(19) United States
(12) Patent Application Publication
(10) Pub. No.: US 2012/0305095 A1
(43) Pub. Date: Dec. 6, 2012

(54) CPVC PIPES, FITTINGS AND TUBULAR CONDUITS IN MARINE VESSELS

(75) Inventor: Solomon Zittrer, Houston, TX (US)

(73) Assignee: LUBRIZOL ADVANCED MATERIALS, INC., Cleveland, OH (US)

(21) Appl. No.: 13/577,267

(22) PCT Filed: Feb. 7, 2011
(86) PCT No.: PCT/US2011/023873

§ 371 Date: Aug. 6, 2012

Related U.S. Application Data
(60) Provisional application No. 61/302,197, filed on Feb. 8, 2010.

(51) Int. Cl. B60P 3/30; B23P 11/00

(52) U.S. Cl. 137/15.01; 137/899

(57) ABSTRACT

A marine vessel (100) includes pipes and tubular fluid conduits which are a part of a waste water management system (102). The waste water management system includes CPVC piping (104) that is used to transport at least one of black water or gray water. The CPVC piping meets at least one fire endurance test set forth by the International Maritime Organization. Additionally or alternatively, the CPVC piping meets at least one test set forth in IMO A.653 (16).

### FIELD OF INVENTION

This invention relates to fittings, pipes and tubular conduits which may be classified in U.S. Class 138.

### BACKGROUND OF INVENTION

Cleaning the global water supply is becoming a high priority for many governing bodies, which are imposing strict environmental regulations on those doing business on land or at sea. In marine applications, a significant amount of wastewater can be generated. The wastewater generated in marine applications may include contaminants such as fecal coli form, cryptosporidium and giardia, suspended solids and more, all of which may have a detrimental effect on water quality and the overall environment. As a result, various marine sanitation treatment methods, apparatuses, and systems are utilized to lessen the environmental impact pertaining to wastewater. Example marine sanitation treatment methods include physical/chemical separation methods, biological treatment methods, and electrolytic treatment methods.

Physical/chemical separation involves a flow-through device that treats liquid waste chemically (Cl₂ of NaOCl, for example) and pumps sewage overboard as permitted. Solids are separated from liquids by a screen and thereafter macerated and transferred to storage for dumping in non-restricted zones. This process involves the transportation, storage, and handling of hazardous chemicals. This process also requires a relatively large footprint and periodic manual cleaning of the equipment.

Biological treatment involves the use of microorganisms (bacteria colonies) to feed on the waste in the presence of oxygen and naturally digested waste. Large collection tanks receive and aerate the wastewater, and excess/dead microorganisms with inert sludge are separated by settling. The clarified liquid from the process is disinfected, typically with a hazardous chemical, and discharged as permitted. This process can take approximately 30 hours to complete and requires a relatively large footprint. The equipment also tends to be heavy, and in periods of low flow or shutdown the bacterial colonies can be destroyed by the induction of certain influents. The destruction of bacteria can cause the sewage to become septic, creating toxic gases such as hydrogen sulphide and methane.

Electrolytic treatment systems mix sewage with seawater to flow through an electrolytic cell. A DC current electrolyses the seawater creating an oxidant (typically sodium hypochlorite) that oxidizes the organic material and kills off the disease-carrying pathogens. Due to increasingly difficult standards associated with wastewater management on marine vessels, however, improvements in waste water management methods/apparatuses/systems are desired.

Black and grey water drain lines on offshore vessels, such as ships and offshore drilling platforms, is normally made from stainless steel or expensive metal alloys. The environment these drain lines operate in is very corrosive. Even though corrosion resistant metals are used, frequently they must be replaced in 3-5 years because of corrosion. This replacement can be expensive and require metal working tools to perform maintenance on the system.

The metal piping systems used are expensive and heavy. The weight of the metal systems reduces the “payload” weight the vessel can carry. Metal piping systems have been required because normal plastic piping cannot meet the flame and smoke requirements of the applicable standard.

It would be desirable to have a lighter weight, corrosion resistant piping system that could handle black and grey water waste on marine vessels.

### SUMMARY OF THE INVENTION

The following is a brief summary of subject matter that is described in greater detail herein. This summary is not intended to be limiting as to the scope of the claims.

Described herein are various technologies pertaining to marine vessels, including but not limited to ships, offshore platforms, or other vessels. With more particularity, the utilization of chlorinated polyvinyl chloride (CPVC) piping in wastewater applications on marine vessels is described in greater detail herein. For example, CPVC piping can be utilized in drain, waste, and vent (DWV) applications on marine vessels. Additionally, CPVC piping can be utilized in connection with pressure fittings. CPVC piping can further be used in connection with transporting gray water and transporting black water on marine vessels. Gray water can be wastewater received from drains (including sinks and showers), while black water may include sanitary waste.

The CPVC piping on the marine vessel may include various joints, fittings, junctions, and the like. Portions of CPVC piping can be joined together via a bonding agent, a chemical bond, and/or a mechanical linkage. The CPVC piping can be utilized to transport wastewater (black and gray water) to any suitable water treatment system and/or filtration system, including but not limited to physical/chemical separator systems, biological treatment systems, and electrolytic treatment systems.

The CPVC piping described herein can conform to standards set forth by the International Maritime Organization (IMO) for non-metal piping, and furthermore can conform to fire test procedures and standards set forth by the IMO. The CPVC piping described herein is impact resistant, relatively light weight and resistant to corrosion, and may be used in both pressurized and vacuum flow applications. When used in a drain setting, the CPVC piping may have a wall width that conforms to schedule 40 or Schedule 80. Diameter of the CPVC piping when utilized to transport gray water can typically be between one half inch and up to eight inches, while diameter of the CPVC piping when utilized to transport black water can typically be one to eight inches in diameter but may be up to twenty four inches or larger.

Other aspects will be appreciated upon reading and understanding the attached figures and description.

### BRIEF DESCRIPTION OF THE DRAWINGS

FIG. 1 is a block diagram of a marine vessel that comprises a wastewater management system that includes CPVC piping.

FIG. 2 is a block diagram that illustrates CPVC piping utilized to transport black water on a marine vessel.

FIG. 3 is a block diagram that illustrates CPVC piping utilized to transport gray water on a marine vessel.

FIG. 4 illustrates a CPVC piping system having CPVC pipes connected to a CPVC DWV fitting.

### DETAILED DESCRIPTION

Various technologies pertaining to utilization of CPVC piping in marine vessels for transport of wastewater will now be described with reference to the drawings, where like reference numerals represent like elements throughout. In addition, several functional block diagrams of example systems are illustrated and described herein for purposes of explanation.

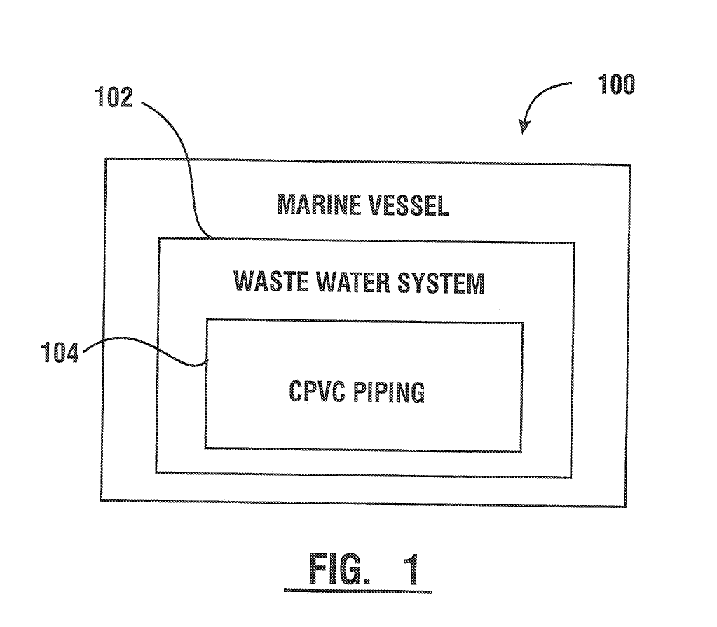

With reference to FIG. 1, a block diagram of a marine vessel 100 is illustrated. The marine vessel 100 may be a ship, a platform such as an oil platform, or other offshore structure. The marine vessel 100 includes a wastewater system 102, which can comprise piping, filters, and/or treatment systems. Example treatment systems that may be included in the wastewater system 102 comprise physical/chemical separation systems, biological treatment systems, and electrolytic treatment systems.

The waste water system 102 comprised CPVC piping 104 is utilized to transport waste water from a first location on the marine vessel 100 to a second location on the marine vessel 100. In an exemplary embodiment, the CPVC piping 104 may be or include a piping system that comprises a plurality of fluid pipe lengths in fluid communication. The pipe lengths are formed of a chlorinated polyvinyl chloride (CPVC) composition. The terms “CPVC composition”, “CPVC pipe”, and“CPVC piping” as used herein can mean that the CPVC composition, the CPVC pipe, and the CPVC piping has a continuous phase of CPVC polymer that has more than 50% by volume of the polymer components is CPVC, preferably more than 70% and more preferably more than 80%. Other polymers can be combined with the CPVC polymer for improving impact resistance, flow enhancers, or other properties, but these other polymers may be used in smaller amounts, normally from about 5-15 percent by weight. The CPVC piping 104 can have a cell class rating of 24448 or 23447.

The CPVC piping 104 can include pipes, fittings, system joints, internal and/or external liners, coverings, coatings, and/or the like. A joint in the CPVC piping 104 includes any suitable method for joining pipes, including bonding via a bonding agent, chemically bonding, laminating, welding, etc. For instance, a joint may include a mechanical linkage between pipes, such as the mechanical linkage described in United States Patent Application Publication No. 2007/0205004, filed on Aug. 16, 2006, and entitled “SYSTEM AND METHOD OF ASSEMBLY OF CPVC FIRE SPRINKLER SYSTEM EMPLOYING MECHANICAL COUPLINGS AND SUPPORTS”, the entirety of which is incorporated herein by reference. Fittings can include bends, elbows, fabricated branch pieces, and/or the like made of CPVC.

In an example, the CPVC piping 104 may be used in drain, waste, and/or vent (DWV) applications on the marine vessel 100. Moreover, the CPVC piping 104 can be utilized to transport black water (sanitary waste) and gray water (waste water from sinks, showers, etc.) on the marine vessel 100. The CPVC piping 104 can be manufactured to be a specific color or set of colors. Thus, CPVC piping utilized to transport black water can be colored a first color while CPVC piping utilized to transport gray water can be colored a second color. The invention of the use of CPVC DWV pattern fittings meeting ASTM D3311, Standard Specification for Drain, Waste and Vent (DWV) Plastic Fitting Patterns, aboard marine platforms, ships and other marine floating structures for the handling of Black and Gray water service and meets the requirements of IMO International Code for Application of Fire Test Procedures, 1998 (FTPCode) “Test for Surface Flammability”, which refers to IMO Resolution A.653(16) Recommendation on Improving Fire Test Procedures for Surface Flammability of Bulkhead, ceiling and Deck Finish Materials, piping materials are held to the same criteria as bulkhead, wall and ceiling linings. The CPVC piping can be marked with an ink or coating to designate source, preferred use, and/or certificates which the pipe holds to indicate it passes certain required tests.

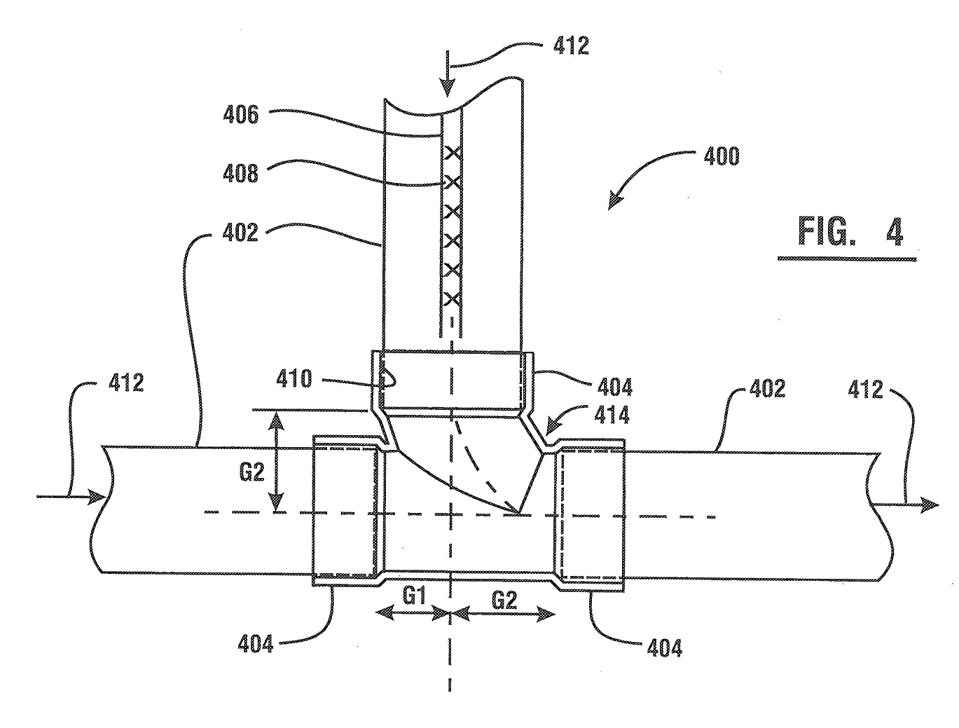

A particular desirable fitting for the CPVC piping of this invention is a CPVC DWV fitting described in U.S. Pat. No. 7,178,557, which is hereby incorporated in its entirety by reference. Such fittings have a bore which has a pitch that changes by at least 0.25 inch per foot of length. This tapered bore allows for complete draining of the black or grey water being transported. The fitting is further described below in connection with FIG. 4. In one embodiment, the DWV fitting is made to Schedule 40 or 80 dimensions (primarily wall thickness of the fitting is adjusted) to correspond to the Schedule 40 or 80 pipe and meets DWV pitch requirements. Having matching Schedule 40 or 80 dimensions in both the fittings and the pipe assures complete draining of the black or grey water.

Straight lengths of pipe can be connected to the above fitting by any common means for joining CPVC pipes. The most preferred method of joining the fitting with the pipe is to use a solvent cement. The solvent cement is usually made by dissolving CPVC resin in a suitable solvent or mixture of solvents. These types of solvent cements are commercially available and thus will not be described further herein.

Pursuant to an example, the CPVC piping 104 may conform to standards imposed by the International Maritime Organization (IMO) for maritime piping systems, fire endurance, flammability, etc. Specifically, the CPVC piping 104 can conform to standards and test procedures described in IMO A.735 as well as standards and test procedures described in IMO A.653.

The CPVC piping 104 can have sufficient strength to take account of severe coincident conditions of pressure, temperature, the weight of the CPVC piping 104, and any static or dynamic load imposed by any portion of the wastewater system 102. To assure adequate robustness of the CPVC piping 104, such CPVC piping 104 can have a predefined minimum wall thickness to assure adequate strength of the CPVC piping 104 for utilization on the marine vessel 100. The wall thickness of the CPVC piping 104 can also be selected based at least in part upon expected handling of the CPVC piping 104, transportation of the CPVC piping 104, personnel traffic pertaining to the CPVC piping 104, etc. For example, the wall thickness of at least a portion of the CPVC piping 104 may conform to schedule 80 (an indicator of wall thickness). Thus, for instance, drains in the CPVC piping 104 may have a wall thickness that conforms to Schedule 80. In another example, all piping in the CPVC piping 104 may have wall thickness that conforms to Schedule 80 or Schedule 40.

As indicated above, the CPVC piping 104 can include fittings, joints, and the like. The fittings, joints, and methods of joining can meet performance standards imposed on pipes in the CPVC piping 104.

The CPVC piping 104 can be designed to handle certain amounts of internal pressure. For example, the CPVC piping 104 can be designed for an internal pressure not less than a maximum working pressure to be expected under operating conditions or a highest set pressure on a safety valve or pressure relieve device corresponding to the CPVC piping 104. The internal pressure rating for a pipe in the CPVC piping 104 can be determined by dividing the short-term hydrostatic test-failure pressure by a safety factor of four or the long-term (e.g., greater than one hundred thousand hours) hydrostatic test failure pressure by a safety factor of 2.5, whichever is the lesser. The test failure pressure can be verified experimentally or by a combination of testing and calculation methods.

The CPVC piping can also be designed to handle certain amounts of external pressure. External pressure can be taken into consideration when vacuum conditions may exist inside a portion of the CPVC piping 104 or a head of liquid acts on the outside of a portion of the CPVC piping 104. The CPVC piping 104 can be designed for an external pressure not less than the sum of the maximum potential head of liquid outside the pipe plus vacuum (1 bar). The external pressure rating for a pipe in the CPVC piping 104 can be determined by dividing the collapse test pressure by a safety factor of three. The collapse test pressure can be verified experimentally or by a combination of testing and calculation methods.

With respect to axial strength pertaining to the CPVC piping 104, the CPVC piping 104 can be designed such that the sum of the longitudinal stresses due to pressure, weight, and other dynamic and sustained loads does not exceed an allowable stress in the longitudinal direction. Additionally, the CPVC piping 104 can be manufactured/installed while taking into consideration thermal expansion, contraction, and external loads.

The CPVC piping 104 is manufactured such that the maximum working temperature is at least twenty degrees Celsius lower than the minimum heat distortion temperature (determined according to ISO 75 method A or some equivalent) of the resin of the CPVC. The minimum heat distortion temperature of the CPVC can be at least 80 degrees Celsius.

Still further, the CPVC piping 104 can be impact resistant, such that the resistance to impact conforms to applicable standards.

Moreover, the CPVC can be resistive to environmental effects, including but not limited to ultraviolet rays, saltwater exposure, temperature, humidity, etc. Thus, these and other environmental effects do not degrade the mechanical and physical properties of the CPVC piping 104 below values required to meet IMO guidelines. For instance, the CPVC piping 104 can be subjected to laboratory aging tests for resistance to various substances prior to being utilized in the wastewater system 102 as is well understood by those skilled in the art.

In applications where design loadings incorporate a significant cyclic or fluctuating component, fatigue of the CPVC piping 104 can be taken into consideration during installation of such piping 104.

Still further, the CPVC piping 104 can be resistive to erosion. For instance, possible effect of erosion can be taken into consideration when the fluid in the CPVC piping 104 is moving at high flow velocities, has abrasive characteristics, and/or where flow path discontinuities produce excessive turbulence. For instance, thickness of walls of the CPVC piping 104 can be increased in such environments, liners can be added, etc.

The CPVC piping 104 is also configured such that absorption of fluid by the CPVC piping 104 does not cause a reduction of mechanical and physical properties of the CPVP piping 104 below those required by the pertinent standards. The CPVC piping 104 is configured such that fluid being carried by such piping 104 does not permeate through the wall of the piping 104. For instance, the CPVC piping 104 may be subjected to testing for degradation by the fluids it is intended to transport prior to being utilized in the wastewater system 102.

The CPVC piping 104 is configured to be compatible with fluid being carried thereby or in which the piping 104 is immersed, such that the design strength of the CPVC piping 104 does not degenerate below a suitable standard.

The CPVC piping 104 additionally meets fire endurance requirements set forth by the IMO. The fire endurance of a piping system is the capability to maintain its strength and integrity (e.g., capable of performing its intended function) for some predetermined period of time while exposed to fire that reflects anticipated conditions. The CPVC piping 104 can conform to at least one of three different levels of fire endurance. For instance, the CPVC piping 104 can conform to a highest level of fire endurance, which ensures the integrity of the CPVC piping 104 during a full-scale hydrocarbon fire. Thus, the CPVC piping 104 can be utilized to carry flammable liquid. In another example, the CPVC piping 104 can conform to a second fire endurance standard, such that the CPVC piping 104 can be utilized in systems essential to the safe operation of the marine vessel 100 after a short fire duration, allowing the wastewater system 102 to be restored after the fire has been extinguished. In still yet another example, the CPVC piping 104 can conform to a third level of fire endurance. Such third level is considered to provide the fire endurance necessary for a water-filled piping system to survive a local fire of short duration, and the functions of the CPVC piping 104 can be restored after the fire has been extinguished.

With more detail pertaining to fire endurance of the CPVC piping 104, level one fire endurance is a standard for piping systems essential to the safety of the marine vessel 100 and those systems outside machinery spaces where loss of integrity may cause outflow of flammable liquid and worsen the fire situation. Thus, the CPVC piping 104 can be designed to endure a fully developed hydrocarbon fire for a long duration without loss of integrity under dry conditions. For instance, the CPVC piping 104 can be configured to pass a first fire endurance test specified by the IMO (described below) for a duration of one hour without loss of integrity in dry condition.

Further, the CPVC piping 104 can be configured to meet the level two fire endurance standard. Thus, the CPVC piping 104 can be designed to endure a fire without loss of the capability to restore the function of the CPVC piping 104 after the fire has been extinguished. Thus, the CPVC piping 104 can pass the fire endurance test specified by the IMO for a duration of at least thirty minutes in the dry condition.

Additionally, the CPVC piping 104 can be configured to meet the level three fire endurance standard. Thus, the CPVP piping 104 can be designed to endure a fire without loss of the capability to restore the function of the CPVC piping 104 after the fire has been extinguished. Therefore, the CPVC piping 104 can be configured to pass a different fire endurance test for at least thirty minutes in the wet condition.

The CPVC piping 104 utilized in the waste water system 102 can have low frame spread characteristics as set forth by test procedures set forth by the IMO A.653(16) as modified for pipes.

The CPVC piping 104 can also be static dissipative. Thus, the CPVC piping 104 can be employed through hazardous areas. That is, the resistance per unit length of piping, bends, elbows, fabricated branch pieces, etc. in the CPVP piping 104 does not exceed 1×10⁵ Ω/m and the resistance from earth to any point in the CPVC piping 104 does not exceed 1×10⁶Ω. Pipes and fittings in the CPVC piping 104 may be made static dissipative by providing a coating of static dissipative material onto the outside surface.

In addition, in some instances one or more sections of the CPVC piping 104 can have fire-protective coating applied thereto to meet the aforementioned fire endurance standards. In such case, the CPVC piping can be delivered from the manufacturer with the protective coating in place, in which case on-site application of protective coating would be limited to what is necessary for installation purposes (e.g., joints). In another example, protective coating can be applied on-site. When protective coating is used, liquid-absorption properties of the coating can be considered, such that the protective properties of the coating are not diminished when exposed to salt water, oil, or bilge slops. Further, the fire-protective coatings that may be applied to the CPVC piping 104 do not degrade due to environmental effects over time, such as ultraviolet rays, exposure to salt water, temperature and humidity. The fire-protective coating may also not degrade due to thermal expansion, resistance against vibrations, and elasticity. Additionally, any coating applied to the CPVC piping 104 is not subject to flaking, chipping, or powdering. Moreover, any fire-protective coating applied to the CPVC piping 104 can meet minimum impact resistance requirements as set forth, for instance, by the IMO.

The CPVC piping 104 can be manufactured such that it meets some suitable standard. For instance, the CPVC piping 104 can meet ISO 9001, “Quality systems—Model for quality assurance in design/development, production, installation and servicing”, or equivalent standard. The dimensions and tolerances of the CPVC piping 104 can also conform to a recognized standard.

Piping and fittings in the CPVC piping 104 can be marked (e.g., permanently) with identification in accordance with a recognized standard, where the markings include pressure ratings, the design standard that the pipe or fitting is manufactured in accordance with, and the material system with which the pipe or fitting is made. Additionally, each length of pipe in the CPVC piping 104 can be tested at the manufacturer's production facility to a hydrostatic pressure not less than 1.5 times the rated pressure of the pipe.

With respect to installation of the CPVC piping 104 in the waste water system 102, selection and spacing of pipe supports can be determined as a function of allowable stresses and maximum deflection criteria. Spacing of supports of the CPVC piping 104 are not greater than any recommended spacing provided by the manufacturer. The supports in the CPVC piping 104 can be selected and placed based at least in part upon dimensions of pipe being supported, mechanical and physical properties of the pipe, mass of the pipe and contained fluid, forces, water hammer, vibration, maximum accelerations to which the CPVC piping 104 may be subjected, and the type of support.

Each support can evenly distribute the load of the pipe and contents thereof over the full width of the support and can be designed to minimize wear and abrasion. Additionally, heavy components in the waste water system 102, such as valves and expansion joins, can be independently supported. Additionally, during installation, suitable provisions can be made in each pipeline to allow for relative movement between pipes made of CPVC and other types of piping (e.g., steel) For instance, differences in coefficients of thermal expansion can be considered as well as deformation of a ship's hull and/or structure. When thermal expansions are calculated, the system working temperature and the temperature at which assembling is performed can be taken into consideration.

In some instances, allowances can be made in the waste water system 102 for temporary point loads, wherein such allowances can include at least the force exerted by a load (person) of 100 kilograms at mid-span on any pipe of more than one hundred millimeter outside diameter.

As indicated above, pipes in the CPVC piping 104 can be coupled using adhesive-bonded, flanged, or mechanically coupled joints. When adhesives are used, such adhesives can be suitable for providing a permanent seal between the pipes and fittings throughout the temperature and pressure range of an intended application. Tightening of flanged or mechanically coupled joints can be performed in accordance with instructions of a manufacturer.

Techniques utilized for joining CPVC pipes can be in accordance with a defined standard, such as MSC/Circular 449, which requires the fabrication to be in accordance with the manufacturer's installation guidelines, IMO Resolution A.753(18) section 4.4.5 and 4.4.6, ASME B31.3 and that personnel performing such tasks be qualified to the satisfaction of an authoritative body, and that each bonding procedure be qualified prior to shipboard piping installation commencing.

After the CPVC piping 104 has been installed, the CPVC piping 104 can be subjected to a pressure test not less than 1.0 times the design pressure of the system. When utilized in non-essential services, the CPVC piping 104 can be checked for leakage under operational conditions.

In some instances, portions of the CPVC piping 104 may need repair while the marine vessel 100 is at sea. Accordingly, necessary materials and tools can be placed on board the marine vessel 100. Repairs to CPVC piping 104 are capable of exhibiting the same mechanical and physical properties as the original piping.

Returning again to fire endurance, example tests for establishing levels of fire endurance are described. The CPVC piping 104 can be configured to meet one or more of such tests.

### Test 1

Test one is a furnace test with fast temperature increase that is likely to occur in a fully developed liquid hydrocarbon fire. The time/temperature of the furnace can be as follows:

at the end of 5 minutes: 945 degrees Celsius;

at the end of 10 minutes: 1033 degrees Celsius;

at the end of 15 minutes: 1098 degrees Celsius;

at the end of 60 minutes: 1100 degrees Celsius.

The accuracy of the furnace can be controlled as follows: during the first ten minutes of the test the area under the curve of mean furnace temperature is not to vary by more than ±15 percent. During the first half hour of the test the area under the curve of mean furnace temperature is not to vary by more than ±10 percent of the area under the standard curve. For any period after the first half hour of the test the area under the curve of mean furnace temperature is not to vary by more than ±5 percent of the area under the standard curve. At any time after the first ten minutes of the test the mean furnace temperature is not to differ from the standard curve by more than ±100 degrees Celsius.

The test specimen can be prepared with joints and fittings intended for use in the proposed application. The number of specimens can be sufficient to test typical joints and fittings, including joints between non-metal and metal pipes and fittings to be used. The ends of the specimen can be closed. One of the ends can allow pressurized nitrogen to be connected. The pipe ends and closure can be outside the furnace. The general orientation of the specimen is to be horizontal and can be supported by one fixed support with the remaining supports allowing free movement. The free length between supports is not to be less than eight times the pipe diameter. To pass the test, the CPVC piping 104 can be configured with a thermal insulation, which can include a covering. The test procedure can include the insulation and covering.

If the insulation includes or is liable to absorb moisture, the specimen is not to be tested until the insulation has reached an air-dry condition. An air-dry condition is defined as equilibrium with an ambient atmosphere of 50% relative humidity at 20±5 degrees Celsius. Special samples can be used for moisture content determination and conditioned with the test specimen. These samples can be constructed as to represent the loss of water vapour from the specimen by having similar thickness and exposed faces.

A nitrogen pressure inside the test specimen can be maintained automatically at 0.7±0.1 bar during the test. The pressure inside the pipe and nitrogen flow into and out of the specimen can be recorded in order to indicate leakage.

During the test, no nitrogen leakage from the sample is to occur. After termination of the furnace test, the test specimen and the fire-protective coating, if any, can be allowed to cool in still air to ambient temperature and then tested to the rated pressure of the pipes as described above. The pressure is to be held for a minimum of fifteen minutes without leakage. The hydrostatic test can be conducted on bare pipe.

### Test 2

Test 2 is a test method for fire endurance of water-filled piping. A propane multiple-burner test with fast temperature increase can be utilized. For piping up to 152 mm in diameter, the fire source can consist of two rows of five burners. A constant heat flux averaging 113.6 kW/m² (±10 percent) can be maintained 12.5±1 cm above the centerline of the burner array. This flux can correspond to a pre-mix flame of propane with a fuel flow rate of 5 kg/h for a total heat release rate of 65 kW. The gas consumption can be measured with an accuracy of at least ±3 percent in order to maintain a constant heat flux. Propane with a minimum of 95 percent purity can be employed.

For piping greater than 152 mm in diameter, an additional row of burners can be included for each 51 mm increase in pipe diameter. A constant heat flux averaging 113.6 kW/m² (±10 percent) can still be maintained at the 12.5±1 cm height above the centerline of the burner array. The fuel flow can be increased as required to maintain the designated heat flux.

The burners can be of type “Sievert No. 2942” or equivalent which produces an air-mixed flame. The inner diameter of the burner heads can be 29 mm. The burner heads can be mounted in the same plane and supplied with gas from a manifold. If necessary, each burner can be equipped with a valve to adjust the flame height.

The height of the burner stand can be adjustable, and can be mounted centrally below the test pipe with the rows of burners parallel to the pipe's axis. The distance between the burner heads and the pipe can be maintained at 12.5±1 cm during the test. The free length of the pipe between its supports can be 0.8±0.05 m.

For the test specimen, each pipe can have a length of approximately 1.5 m. The test pipe can be prepared with permanent joints and fittings intended to be used. Only valves and straight joints versus elbows and bends can be subject to testing as the adhesive in the joint is the primary point of failure. The number of pipe specimens can be sufficient to test all typical joints and fittings. The ends of each pipe specimen can be closed, and one of the ends should allow pressurized water to be connected.

If any insulation applied to the pipe contains or is liable to absorb moisture, the specimen should not be tested until the insulation has reached an air-dry condition (described above). Special samples can be used for moisture content determination and conditioned with the test specimen. Such samples can be constructed as to represent the loss of water vapour from the specimen by having similar thickness and exposed faces. The pipe samples can rest freely in a horizontal position on two V-shaped supports. The friction between pipe and supports can be minimized, and the supports may consist of two stands. A relief valve can be connected to one of the end closures of each specimen.

The test can be carried out in a sheltered test site to prevent any draught influencing the test. Further, each pipe specimen can be completely filled with deaerated water to exclude air bubbles. The water temperature is not to be less than 15 degrees Celsius at the start and can be continuously measured during the test. The water inside the sample can be stagnant and the pressure can be maintained at 3±0.5 bar during the test.

To be accepted as passing the test, no leakage from the samples should occur except that slight weeping through the pipe wall may be accepted. After termination of the burner regulation test, the test sample, together with fire-protective coating (if any) can be allowed to cool to ambient temperature and then tested to the rated pressure of the pipes as defined above. The pressure is to be held for a minimum of 15 minutes without signification leakages (e.g., not exceeding 0.2 liters/minute). Where practicable, the hydrostatic test can be conducted on bare pipe.

### Test 3

A third test can be applied to the CPVC piping 104 to test for flame spread of the CPVC piping 104. The CPVC piping can be configured to pass such test.

Flame spread of plastic piping can be determined by, for instance, IMO resolution A.653(16) entitled “Recommendation on Improved Fire Test Procedures for Surface Flammability of Bulkhead, Ceiling and Deck Finish Materials” with the following modifications. Test can be made for each pipe material and size. The test sample can be fabricated by cutting pipes lengthwise into individual sections and then assembling the sections into a test sample as representative as possible of a flat surface. A test sample can consist of at least two sections. The test sample can be 800±5 mm long, and all cuts can be made normal to the pipe wall.

The number of sections that are to be assembled together to form a test sample can be that which corresponds to the nearest integral number of sections that can make a test sample with an equivalent linearized surface width between 155 mm and 180 mm. The surface width is defined as the measured sum of the outer circumference of the assembled pipe sections that are exposed to the flux from the radiant panel. The assembled test sample can have no gaps between individual sections.

The assembled test sample can be constructed in such a way that the edges of two adjacent sections coincide with the centerline of the test holder. Further, the individual test sections can be attached to the backing of a calcium silicate board using wire inserted at 50 mm intervals through the board and tightened by twisting at the back. The individual pipe sections can be mounted so that the highest point of the exposed surface is in the same plane as the exposed flat surface of a normal surface. The space between the concave unexposed surface of the test sample and the surface of the calcium silicate backing board can be left void. The void space between the top of the exposed test surface and the bottom edge of the sample holder frame can be filled with a high temperature insulating wool if the width of the pipe segments extend under the side edges of the sample holding frame.

The aforementioned tests and procedures corresponding thereto are described in IMO A.753, the entirety of which is incorporated herein by reference.

In addition to the fire endurance tests and the flammability test described above, the CPVC piping 104 can be configured to pass a variety of other tests, including but not limited to a non-combustibility test, a smoke and toxicity test, a test for “A”, “B”, and “F” class divisions, a test for surface flammability, amongst other tests. These tests are described in IMO A.653, the entirety of which is incorporated herein by reference.

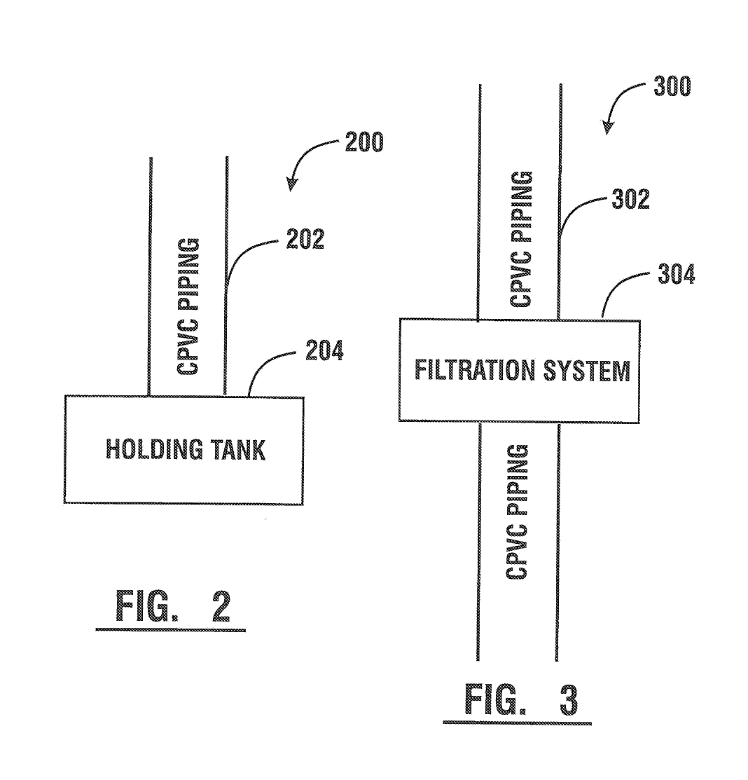

With reference now to FIG. 2, an example system 200 that facilitates transporting black water in a marine vessel is illustrated. The system 200 comprises a portion of CPVC piping 202 that is used in the transport of black water. A holding tank 204 receives the black water and is used to retain the black water while or until a waste water process is undertaken on such black water. In this example system 200, the CPVC piping 202 can have a diameter of up to twenty four inches or larger. Additionally, the CPVC piping 202 can be color-coded to indicate that such piping 202 is utilized in the transport of black water.

Turning to FIG. 3, an example system 300 that facilitates transporting gray water in a marine vessel is illustrated. The system 300 comprises a portion of CPVC piping 302 that is used in the transport of gray water. A filtration system 304 receives the gray water and subjects the gray water to one or more filtration procedures. The gray water can be recycled and utilized thereafter on the marine vessel. The CPVC piping 302 can have a diameter of half inch to eight inches. Further, the CPVC piping 302 can be color-coded to indicate that such piping 302 is utilized in the transport of gray water. The CPVC piping can also be marked with an ink or coating to designate source, preferred use, and/or certificates which the pipe holds to indicate it passes certain required tests.

Turning to FIG. 4, an example CPVC piping system 400 that can be used to transport black or grey water in a waste system on a marine vehicle. The CPVC piping system 400 has a CPVC DWV fitting 414 used to connect three CPVC pipes 402. The three CPVC pipes 402 extend into the receiving flanges 404 of the CPVC fitting. The inside surface of the flanges 404 are bonded to the outside surface of the CPVC pipe by using CPVC solvent cement in the contact area 410.

FIG. 4 also shows an area 406 of indicia. This is shown on the vertical section of pipe 402, but is preferably on all CPVC pipe sections. The indicia 408 represented in FIG. 4 as “x” can be letters that state the pipe's source, preferred use, pipe standards; such as pressure rating, size, and/or the pipe's compliance with certain specifications. Since the piping of this invention is intended for use on marine vessels to handle waste streams, the piping installations have to be inspected by an official marine agency to assure compliance with the marine standards and safety requirements such as the United States Coast Guard, the American Bureau of Shipping, Bureau Veritas, China Classification Society, Germanischer Lloyd, Det Norske Veritas, Lloyd's Register, RINA, and other approval and classifying agencies. It would be advantageous to all of the approval agencies to have an easy way to identify approved marine piping. This could be accomplished by marking the pipe with lettering stating the standards the pipe meets. The lettering could be applied with an ink or coating which contains optical brightener which would reflect and become visible by the application of a UV light source, such as a black light. The black light would emit a wavelength sufficient to cause the optical brightener in the lettering to become visible. A black light with a typical wavelength of from 200 to 380 nanometer UV emission would make the optical brightener visible. This would let the inspector know that the pipe meets the required marine vessel standard.

The drain, waste, and vent fitting 414 (herein referred to as DWV fitting), shown in FIG. 4, has a slope or fall built into the bore of the fitting. The slope of the bore is about 0.25 inch per foot of length. It is apparent that the distance G1 and G2 are not equal in length. This difference results in the DWV fitting 414 having a built-in slope. The slope in the DWV fitting 414 provides for complete draining of the waste being transported through the piping system. Some typical distances for G1 and G2 for different size diameter fittings are shown in the table below.

| Size (inches) | G1 (inches) | G2 (inches) |
|---|---|---|
| 1½ | 1¾ | 1 |
| 2 | 2 5/16 | 1⅜ |
| 3 | 3 1/16 | 1¾ |
| 4 | 3 15/16 | 2¼ |
| 6 | 5 | 3½ |
| 8 | 6 | 4½ |

Different size DWV CPVC fittings could be made other than those shown above as long as the socket or bore pitch or slope is maintained at about 0.25 inch per foot or greater. In one embodiment, the DWV fitting is made to Schedule 40 or 80 dimensions (primarily wall thickness of the fitting is adjusted) to correspond to the Schedule 40 or 80 pipe and meets DWV pitch requirements. Having matching Schedule 40 or 80 dimensions in both the fittings and the pipe assures the socket or bore pitch or slope is maintained and complete draining of the black or grey water is achieved.

The CPVC pipes 402 are joined to the CPVC DWV fitting 414 preferably by the use of a CPVC solvent cement. CPVC solvent cements are commercially available from several suppliers such as Oaty and IPS. CPVC cements are available in hardware stores and plumbing supply stores. These CPVC solvent cements are typically made by dissolving CPVC resin in a suitable solvent. Usually the CPVC cement contains from about 15 to about 25 weight percent CPVC resin. Various other ingredients can be added to the mixture of CPVC resin and solvent, such as colorants, thicksotropic agents such as silica, heat stabilizers, and the like. Usually, these other ingredients are no more than 5-10 weight percent of the CPVC cement composition. The CPVC cements can be one part cements or two part cements. When two part cements are used, the first part used is usually a cleaning solution consisting mainly of solvent.

To join the CPVC pipe to the CPVC fitting, CPVC solvent cement is first coated on the outside surface of the pipe and inside surface of the fitting socket. The end of the pipe is inserted into the fitting socket and rotated about 90° to assure complete coverage of the cement. An initial set will occur in about 30 minutes (at 60-100° F.) which will allow handling and installation of the piping system. Full cure time will occur in about 1 hour (at 60-100° F., 16-38° C.) which will allow the piping system to be placed into service. The initial set time and the full cure time will vary depending on the ambient temperature and humidity levels of the ambient air. Colder temperatures and higher humidity levels require longer initial set and final cure times, which is well understood by those skilled in the art of installing plumbing systems using CPVC pipe and fittings.

The CPVC pipe system can have other fittings, such as straight connectors, elbows and Y fittings. These fittings can likewise be joined by the use of solvent cement. Mechanical fittings can also be used to join different lengths of CPVC pipe or to join CPVC pipe to metal pipe. The mechanical fittings are usually clam shell type structures with a flexible sealing gasket, such as EPDM rubber, applied to the adjoining sections of pipe and retained in place by pressure of the clam shell mechanical device.

The CPVC pipe shown in this invention specification is an all polymeric pipe. It should be recognized that CPVC composite pipe could also be used. CPVC composite pipe has a layer of CPVC on the outside and inside surfaces and a layer of metal between the outside and inside layer. Composite pipe, although heavier in weight than straight CPVC polymer pipe, can have better fire prevention properties and is more rigid. Composite pipe can be more advantageous for use in small diameter pipes, such as from ½ to 3 inches in nominal diameter pipes. CPVC composite pipes are commercially available from Lubrizol Advanced Materials, Inc. of Cleveland, Ohio, U.S.A.

FIG. 4 shows the direction of flow of the waste in the pipes with arrows 412. The waste is transported from its source, such as toilet, sink, or shower, to a receiving point where it is treated for further use or discharge.

### EXAMPLE

This example is presented to show the performance of the CPVC piping tested for surface flammability. The CPVC pipe used in the Example was Corzan® CPVC pipe. One could also use Corzan® HP pipe which is a higher design basis pressure pipe, if higher pressure or thinner pipe is desired for a particular application. The screening testing was conducted in general accordance with Part 5 of the Annex 1 of the International Maritime Organization (IMO) International Code for Application of Fire Test Procedures, 1998 (FTP Code), which refers to IMO Resolution A.653(16). Table 1 shows the pipe material tested.

TABLE 1
Material Identification and Description.

| | | Wall | | |
|---|---|---|---|---|
| Material ID/Trade Name | Description | Thickness | Mass | Color |
| Chlorinated Polyvinyl | ½ inch | 3.2 mm | 82 g | Gray |
| Chloride (CPVC)/Corzan ® | schedule | | | |
| From Lubrizol Advanced | 40 Pipe | | | |
| Materials, Inc. | | | | |
| Chlorinated Polyvinyl | ½ inch | 4.2 mm | 102 g | Gray |
| Chloride (CPVC)/Corzan ® | schedule | | | |
| From Lubrizol Advanced | 80 Pipe | | | |
| Materials, Inc. | | | | |
| Chlorinated Polyvinyl | 8 inch | 13.7 mm | 1270 g | Gray |
| Chloride (CPVC)/Corzan ® | schedule | | | |
| From Lubrizol Advanced | 80 Pipe | | | |
| Materials, Inc. | | | | |

The specimens were placed in a conditioned environment maintained at 23° C.±2° C. and 50%±5% relative humidity until prior to sample preparation and testing. Each sample measured nominally 804 mm in length and had to be trimmed slightly for testing.

Before testing, the edges and back surfaces of the test specimen were wrapped in aluminum foil, backed with 10 mm calcium silicate board, and placed in a sample holder with the convex face exposed. Sections of pipe were placed side-by-side to obtain the required width. The sections were wired to the backer board to secure them into the test frame.

The testing was conducted in general accordance with Part 5 of Annex 1 of the IMO FTP Code, i.e., a single specimen of each material was tested rather than the three specimens by the standard; all other testing protocols were adhered to. A summary of the test results is provided in Tables 2 and 3.

TABLE 2
Test Results for ½ Inch Schedule
40 Pipe and ½ Inch schedule 80 Pipe.

| | IMO Criteria | | ½ Inch | | ½ Inch | |
|---|---|---|---|---|---|---|
| | for Pipe | | Schedule | | Schedule | |
| Parameter | Materials | | 40 Pipe | | 80 Pipe | |
| Critical Flux at | ≧20.0 | kW/m² | 37.2 | kW/m² | 21.9 | kW/m² |
| Extinguishment | | | | | | |
| (CFE) | | | | | | |
| Heat for Sustained | ≧1.5 | MJ/m² | 19.4 | MJ/m² | 15.5 | MJ/m² |
| Burning (Q_{sb}) | | | | | | |
| Total Heat Release | ≦0.7 | MJ | 0.1 | MJ | 0.2 | MJ |
| (Qₜ) | | | | | | |
| Peak Heat Release | ≦4.0 | kW | 0.2 | kW | 0.6 | kW |
| Rate (qₚ) | | | | | | |

| | | | |
|---|---|---|---|
| Produces Burning | Not Permitted | None | None |
| Droplets | | | |
| Meets Requirements | — | Yes | Yes |
| of IMO Part 5 | | | |

TABLE 3
Test Results for 8 Inch Schedule 80 Pipe.

| | | |
|---|---|---|
| | IMO Criteria | 8 Inch |
| | for Pipe | Schedule |
| Parameter | Materials | 80 Pipe |

| | | | | |
|---|---|---|---|---|
| Critical Flux at | ≧20.0 | kW/m² | >50.5 | kW/m² |
| Extinguishment | | | | |
| (CFE) | | | | |
| Heat for Sustained | ≧1.5 | MJ/m² | >30 | MJ/m² |
| Burning (Q_{sb}) | | | | |
| Total Heat Release | ≦0.7 | MJ | 0.0 | MJ |
| (Qₜ) | | | | |
| Peak Heat Release | ≦4.0 | kW | 0.0 | kW |
| Rate (qₚ) | | | | |

| | | |
|---|---|---|
| Produces Burning | Not Permitted | None |
| Droplets | | |
| Meets Requirements | — | Yes |
| of IMO Part 5 | | |

The test results shown in Tables 2 and 3 above were based on one test instead of the required 3 tests specified in the standard.

It is noted that several examples have been provided for purposes of explanation. These examples are not to be construed as limiting the hereto-appended claims. Additionally, it may be recognized that the examples provided herein may be permutated while still falling under the scope of the claims.

Thus, the exemplary embodiments described herein achieve desirable objectives, eliminate difficulties encountered in the making and use of prior systems, solve problems, and attain the desirable results described herein.

In the foregoing description certain terms have been used for brevity, clarity, and understanding. However, no unnecessary limitations are to be implied therefrom because such terms are for descriptive purposes and are intended to be broadly construed. Moreover, the descriptions and illustrations herein are given by way of examples and the invention is not limited to the exact details shown and described.

In the following claims, any feature described as a means for performing a function will be construed as encompassing any means capable of performing the recited function, and will not be deemed limited to the particular means shown as performing that function in the foregoing description or mere equivalents thereof.

Having described the features, discoveries, and principles of the invention, the manner in which it is constructed and operated, and the advantages and useful results attained; the new and useful structures, devices, elements, arrangements, parts, combinations, systems, operations, methods, and relationships are set forth in the appended claims.

What is claimed is:

1. A marine vessel comprising:
a waste water system, the waste water system comprising:
a portion of CPVC piping that is utilized in the transport of one of black water or gray water on the marine vessel.

2. The marine vessel of claim 1 being an offshore oil platform.

3. The marine vessel of claim 1 being a ship.

4. The marine vessel of claim 3 being a military ship.

5. The marine vessel of claim 1 being a passenger cruise ship.

6. The marine vessel of claim 1, wherein said CPVC piping transports black water to a treatment system.

7. The marine vessel of claim 1, wherein said CPVC piping transports grey water to a filtration system.

8. The marine vessel of claim 1, wherein said CPVC pipe is marked with an ink or coating to designate source, preferred use, or certificates held by the pipe.

9. The marine vessel of claim 8, wherein said ink or coating contains an optical brightener pigment which is visible by projecting a black UV light on said marking.

10. The marine vessel of claim 9, wherein said black light emits a wavelength of from about 200 to about 380 nanometers.

11. The marine vessel of claim 1, wherein said CPVC pipe has a nominal diameter of from 0.5 inch to 24.0 inches.

12. The marine vessel of claim 11, wherein said CPVC pipe has a nominal diameter of from 1.5 inch to 8.0 inches.

13. The marine vessel of claim 1, wherein said CPVC pipe and optionally the fittings meets the requirements of Schedule 40 or Schedule 80 pipe.

14. The marine vessel of claim 1, wherein said CPVC pipe is a composite CPVC pipe.

15. A marine vessel comprising:
CPVC piping utilizing Drain Waste and Vent and/or pressure fittings that transports one of black water or gray water, the CPVC piping meeting a fire endurance test of IMO A.653 (16).

16. A method of making a black water or grey water drain system on a marine vessel comprising:
(a) providing multiple lengths of CPVC pipe;
(b) providing at least one drain waste vent fitting made from CPVC; and
(c) attaching said CPVC pipe to said fitting.

17. The method of claim 16, wherein said fitting has a bore which has a pitch that changes by at least 0.25 inch per foot of length.

18. The method of claim 16, wherein said pipe and said fitting are attached by the use of a solvent cement.

19. The method of claim 16, wherein said marine vessel is selected from the group consisting of a ship and an offshore oil platform.
